(19) United States
(12) Patent Application Publication
(10) Pub. No.: US 2002/0168486 A1
(43) Pub. Date: Nov. 14, 2002

(54) Decorative ornament with a circular array of outwardly extending members and method of making same

(76) Inventors: Mary M. Yedlin, Glendale, CA (US); Monte A. Yedlin, Glendale, CA (US)

Correspondence Address: Jack C. Munro, Suite 225, 28720 Roadside Drive, Agoura Hills, CA, 91301, US

(21) Appl. No.: 09/855,100

(22) Filed: May 14, 2001

(51) Int. Cl. B32B 15/20; A47G 33/00

(52) U.S. Cl. 428/11; 428/654; 428/7; 428/542.6; 229/87.19

(57) ABSTRACT

A decorative ornament that is constructed by wrapping a pair of sections sequentially onto a core. Each section is composed of thin, pliable sheet material which includes a mass of slits forming a plurality of first upstanding members within one section and a plurality of second upstanding members within the second section. The outer tips of the first upstanding members are free and the apexes of the second upstanding members are free. Both the first section and the second section each include a solid uncut border with these borders to be wound onto the core in an overlapping arrangement. The slits within each section are located transverse to their respective border.

### BACKGROUND OF THE INVENTION

1. Field of the Invention

The field of this invention relates to decorative ornaments and more particularly to a decorative ornament that is to be used as a bow in gift wrapping of packages, holiday ornaments, artificial flowers, decorative displays and other similar types of usages.

2. Description of the Related Art

Decorative ornaments for use in gift wrapping packages are well known. Reference is to be had to U.S. Pat. No. 5,609,928 which is herein incorporated by reference, and also to U.S. patent application Ser. No. 09/544,056 filed Apr. 6, 2000, both by the present inventors. This patent application discloses decorative ornaments that are to be made in a manner similar to the decorative ornament of the present invention. The decorative ornament of this invention creates a bow of different appearance than the aforementioned patent and patent application.

In the past, it has been known to construct decorative bows from ribbon by forming the ribbon into a plurality of loops that extend from a central source. Such bows have been in widespread use for so long that these bows are trite. It is always desirable to continuously construct different configurations of bows so that the decorative bow market will always remain fresh to the consumer.

### SUMMARY OF THE INVENTION

A decorative spiked ornament which utilizes a core upon which is wound a first section of sheet material with this first section of sheet material having a plurality of thin, pliable, upstanding members located in a row with the outer tips of the upstanding members being free. A second section of thin, sheet material having a plurality of pliable loops with this second section to be wound on a core sequentially relative to the first section with the outer ends of the loops, defined as apexes, being maintained free.

A further embodiment of the present invention which utilizes the decorative spiked ornament of the first embodiment where the first section is formed of a polygonal shape.

A still further embodiment of the present invention which utilizes the first embodiment of decorative spiked ornament of this invention with the second section being formed of a trapezoidal shape.

A still further embodiment of the present invention utilizes the first embodiment of decorative spiked ornament where the upstanding members are sharp pointed.

A still further embodiment of the present invention comprises evenly spacing apart the upstanding members within the first embodiment of decorative spiked ornament with there being a slit located between each directly adjacent pair of upstanding members.

A further embodiment of this invention where there is located a series of parallel slits within the first section of sheet material.

A still further embodiment of this invention comprises using as the core an elongated rod within the first embodiment.

A still further embodiment of this invention is where the first section has a first border and a second section has a second border with these borders to overlap with the second border to overlap the first border when it is wound on the core of the first embodiment of this invention.

A still further embodiment of this invention is where there is located an adhesive between the first border and the second border when such are wound on the core within the first embodiment of this invention.

A still further embodiment of this invention is where the first section is longitudinally offset from the second section within the first embodiment of spiked ornament of this invention.

A second embodiment of this invention comprises a decorative spiked ornament which utilizes an elongated, thin, sheet material first section which has a plurality of upstanding members located in juxtaposition and arranged in a row. These upstanding members are fixed to a first border and extend transversely therefrom. Each of the members have a free outer tip. There is utilized an elongated, thin, sheet material, pliable second section having a series of spaced apart slits forming a plurality of loops located in juxtaposition and arranged in a row. Each of the loops are fixed to a second border and extend transversely therefrom. Each of the loops has a free apex. The second section is located against the first section with the first border abutting the second border forming a unified border and forming an assemblage. A core is placed against the assemblage at one end of the unified border with the assemblage to be completely wound on the core producing a decorative ornament which has a center mound from which produce a circular array of elongated spiked members.

A further embodiment of this invention is where the upstanding members of the second embodiment is formed into sharp points.

A still further embodiment of this invention is where the upstanding members of the second embodiment are curves.

A still further embodiment of this invention is where the upstanding members within the second embodiment are all of the same length.

A still further embodiment of this invention is where the upstanding members of the second embodiment are evenly spaced apart.

A still further embodiment of this invention is where the slits are located parallel within the second embodiment of this invention.

A still further embodiment of this invention is where the second section is formed into a trapezoidal shape resulting in the loops all being of a different length.

A still further embodiment of this invention the first section of the second embodiment is of a polygonal shape.

In a still further embodiment of this invention is where the second section of the second embodiment is smaller in area than the first section.

In a still further embodiment of this invention is where the core comprises an elongated rod within the second embodiment.

In a still further embodiment of this invention is where there is located an adhesive between the borders which are wound together on the core within the second embodiment of this invention.

In a still further embodiment of this invention is where the second section is located longitudinally offset from the first section within the second embodiment of this invention.

A still further embodiment of this invention is where the first section is of a different length than the second section within the second embodiment of this invention.

A third embodiment of this invention comprises a method of making a decorative ornament which comprises the steps of forming a first section of thin, sheet material which has a first border from which extends transversely a plurality of upstanding members located in juxtaposition and arranged in a row with each member having a free outer tip. The method also includes forming a second section of thin, sheet material which has a second border from which extends transversely a plurality of second upstanding members located in juxtaposition and arranged in a row with each second upstanding member having a free apex. The method further includes placing the second border against the first border forming an assemblage. Finally, the method includes completely winding the assemblage on a core producing a decorative ornament which has a center mound from which protrudes a circular array of elongated members.

In yet a further embodiment of this invention is where the second section of the method, previously described, has a different area than the first section.

In yet a further embodiment of this invention comprises utilizing the above described method wherein the first section is selected to be of a polygonal shape.

In yet a further embodiment of this invention the above described method utilizes a trapezoidal shape for the second section.

In yet a further embodiment of this invention, the method previously described includes selecting loops for the second upstanding members.

A fourth embodiment of this invention comprises a decorative ornament which utilizes a core upon which are wound a first section of sheet material with this first section of sheet material comprising thin, pliable, first upstanding members located in a row and having free outer tips and a second section of thin, pliable, sheet material with second upstanding members having free apexes. The second section overlaps a portion of the first section leaving the outer tips free and the apexes free.

A further embodiment of this invention comprises a first border with the first section and a second border with the second section of the fourth embodiment. The first upstanding members extend outwardly from the first border and the second upstanding members extend outwardly from the second border. The first border and the second border are located in abutting juxtaposition.

A still further embodiment of decorative ornament which utilizes the fourth embodiment of decorative ornament where the second upstanding members comprise loops.

A still further embodiment of the present invention utilizes the fourth embodiment where the first upstanding members are evenly spaced apart with there being a slit located between each directly adjacent pair of first upstanding members. The second upstanding members are also evenly spaced apart with there also being a slit located between each adjacent pair of second upstanding members.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a top plan view of the initial configuration of elongated sheet material that is used to produce a pair of the first sections that are used in forming the decorative spiked ornament of the present invention;

FIG. 2 is a top plan view showing the pair of first sections that are produced from the structure of FIG. 1 that will be used in the forming of the first embodiment of decorative spiked ornament of the present invention;

FIG. 3 is a view of a single first section upon which has applied an adhesive to a border of the first section with a release liner being shown mounted to normally cover the adhesive strip prior to usage with a portion of this liner being removed;

FIG. 4 is a top plan view of the initial configuration of second section which is utilized in forming of the first embodiment of decorative spiked ornament of the present invention showing an adhesive which is applied onto a second border with the release liner being in place to normally cover the adhesive prior to usage with a small portion of the liner being separated exposing the adhesive;

FIG. 5 is a top plan view similar to FIG. 4 but with the second section being folded over upon itself so that the borders of the second section are abutting and secured together by the adhesive resulting in the second section forming a plurality of loops that are arranged in a row;

FIG. 6 is an end view of the second section taken along line 6-6 of FIG. 5;

FIG. 7 is a top plan view showing the positioning of a second section in conjunction with a first section in order to form the first embodiment of decorative spiked ornament of this invention;

FIG. 8 is a view similar to FIG. 7 but showing the connection of a core to an adhesive strip of the border that is located on the border of the second section;

FIG. 9 is a view similar to FIG. 8 but showing the winding procedure which results in the production of the first embodiment of decorative spiked ornament of the present invention;

FIG. 10 is a side elevational of the first embodiment of decorative spiked ornament of the present invention;

FIG. 11 is a top plan view of the first embodiment of decorative spiked ornament of the present invention;

FIG. 12 is a view similar to FIG. 9 but where the first section is of a different configuration resulting in the production of a second embodiment of decorative spiked ornament of the present invention showing the core being wound in conjunction with the first section and the second section;

FIG. 13 is a top plan view of the second embodiment of decorative spiked ornament of the present invention;

FIG. 14 is a view similar to FIG. 9 but where the first section comprises a different configuration to produce a yet further different configuration producing a third embodiment of decorative ornament of the present invention;

FIG. 15 is a view similar to FIG. 14 but depicting partial winding of the second section and the first section onto the core; and

FIG. 16 is a top plan view of the third embodiment of decorative ornament of the present invention.

### DETAILED DESCRIPTION OF THE INVENTION

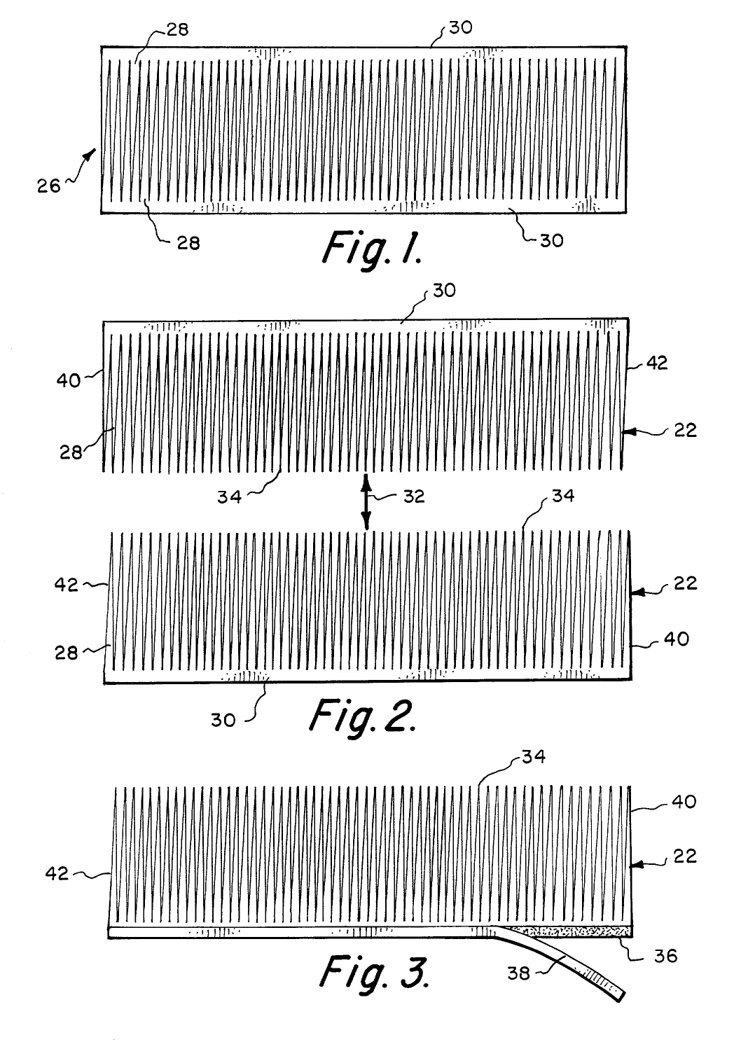

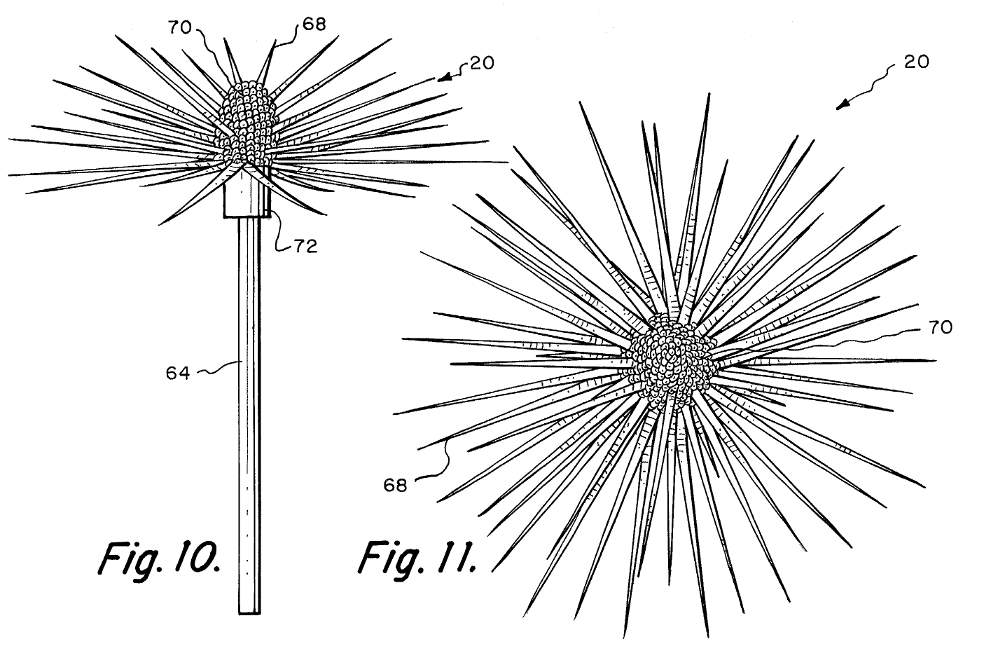

Referring particularly to the drawings, there is shown in FIGS. 1-11 a first embodiment 20 of decorative spiked ornament of this invention which utilizes a first section 22 and a second section 24. Sections 22 and 24 are shown separate in the drawings. However, it is to be within the scope of this invention that sections 22 and 24 could be formed as one integral structure. Both sections 22 and 24 are constructed of thin, sheet material with a typical material comprising a flexible plastic, polyester, polypropelene, including blow polypropelene ribbon material, vinyl, paper or laminates thereof such as combining polyester and paper. The material can be tinted, printed, metalized, embossed, holographic and may include other similar types of processes. The thickness of the sections 22 and 24 would normally comprise between one-half mil to ten mil.

In order to produce the first section 22, a length is selected of the thin, pliable, sheet material that is used to produce the section 22. This length is shown as initial section 26 in FIG. 1 of the drawings. The initial section 26 will be formed from a die cut pattern which will result in the forming of a row of upstanding members 28 which are located in a row. The upstanding members 28 may or may not all be of the same width. In the section shown in FIG. 1, there are fifty-eight in number of upstanding members 28. The number of upstanding members 28 could be increased or decreased. The cutting of the upstanding members is between a pair of solid uncut borders 30. The upstanding members 28 extend transversely relative to a border 30. In the cutting of the initial section 26, there is formed a pair of the first sections 22 and they are separated from each other in FIG. 2 of the drawings. This means that for each initial section 26 there is produced two in number of the first sections 22. The pair of first sections 22 are shown being separated within FIG. 2 as indicated by arrow 32.

When making a close observation of the configuration of the first section 22, it can be seen that each of the upstanding members 28 has a sharp outer tip 34. Each of the upstanding members 28 take the shape of very narrow triangle. It is to be understood that each decorative ornament that is produced is a single length of a first section 22 is utilized with a typical length being in the range of seven to fifteen inches.

On one side of the border 30 there is applied a layer of adhesive 36. Prior to usage, this layer of adhesive 36 is normally covered by a release liner strip 38. It is considered to be within the scope of this invention that both sides of the border 30 could include a layer of adhesive 36 and a separate release liner strip 38 although only a single application of adhesive on one side of the border 30 is required. The first section 22, for purposes of description, will be defined as having a right edge 40 and a left edge 42. The use of adhesive 36 is optional.

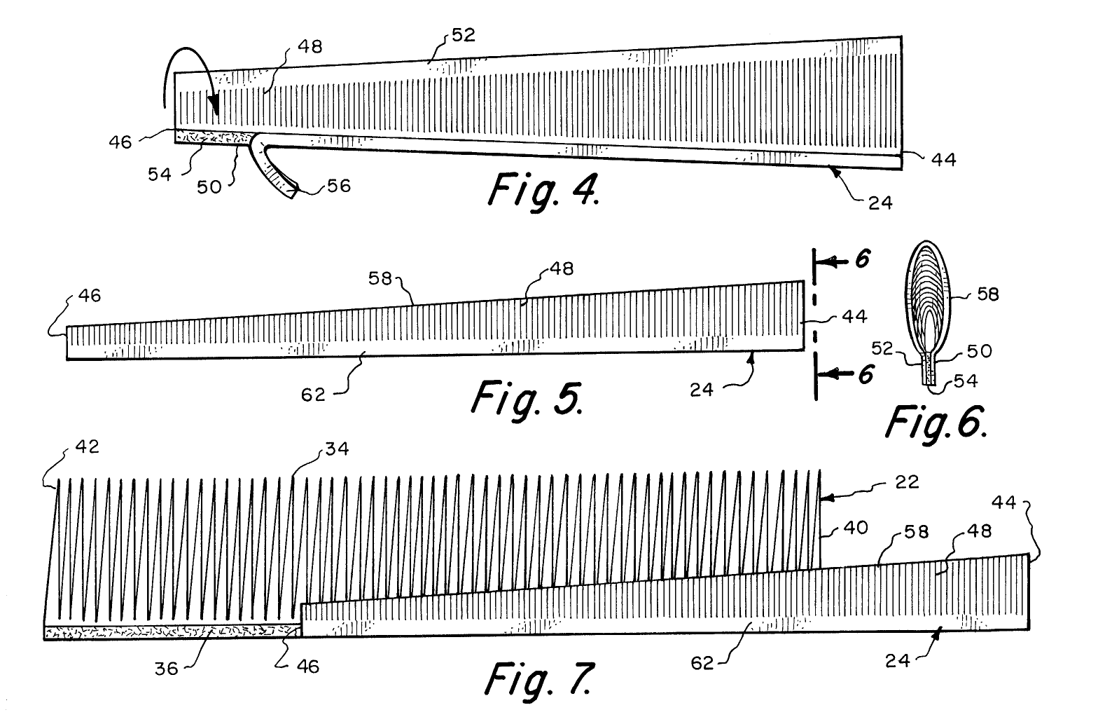

The second section 24 is basically trapezoidal in shape having a right end 44 and a left end 46. The ends 44 and 46 are located parallel. It is not mandatory that the second section 24 be trapezoidal shape although it is preferred. The second section 24 includes a mass of slits 48 that are located between a pair of solid uncut borders 50 and 52. The width of each of the borders 50 and 52 are basically identical and will normally range between one-sixteenth of an inch to one-half inch. Therefore, it can be seen in FIG. 4 that each of the slits 48 are of a different length with the shorter slit being located directly adjacent of the left end 46 and the longest slit 48 being located directly adjacent the right end 44. The inside surface of the solid border 50 is to include a layer of adhesive 54. This adhesive 54 is normally protected prior to usage by a release liner strip 56. The inside surface of the border 52 is to be folded over against the adhesive 54 along the entire length of the border 50. Use of adhesive 54 is not mandatory. This will result in forming between each directly adjacent pair of slits 48 a loop 58. It is to be noted that the slits 48 are located parallel to each other. However, the constructing of parallel slits 48 is not mandatory. The smallest loop 58 is located at the left end 46 with the largest loop 58 located at the right end 44. The second section 24 could be rectangular which will result in all of the loops 58 being of the same length. The configuration of the loops 58 can be basically seen by observing FIG. 6. Each loop 58 has an outer free end or apex 57.

On the exterior surface of the border 52 is located an adhesive strip 60 which is covered by a release liner strip 62. The normal length of the second section will generally be around fourteen inches in length, however, any length could be used.

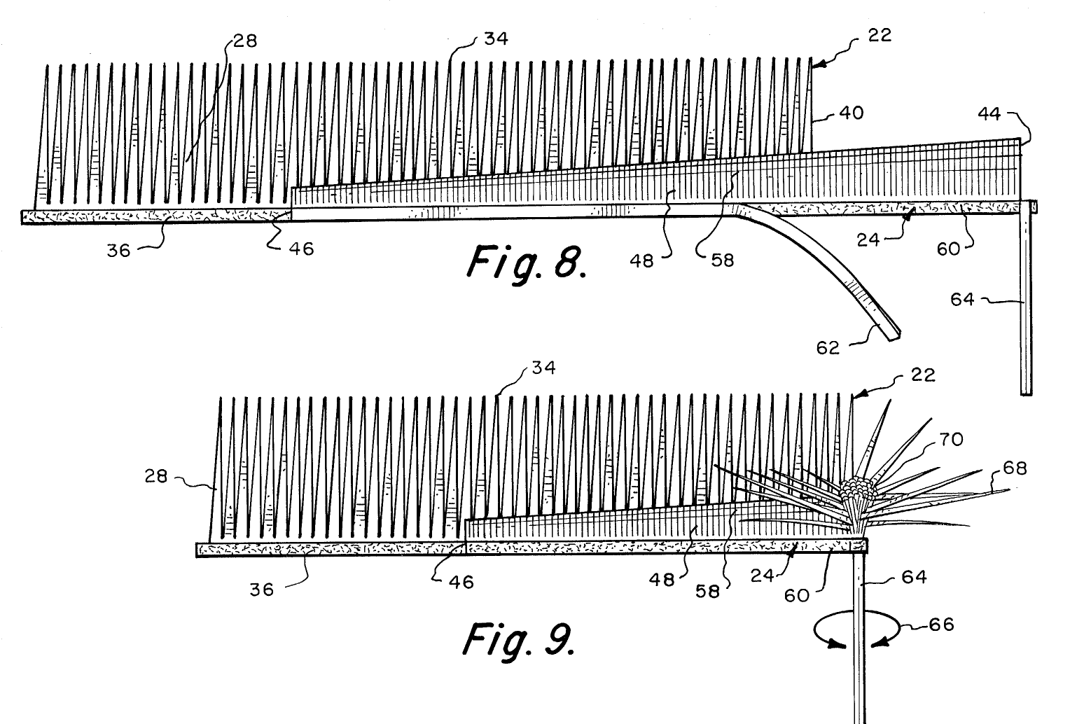

The border 50 is to be laid against the adhesive strip 36 after removal of the release liner strip 38. This connecting between the first section 22 and the section 24 is accomplished in an offset manner meaning that there is a space from the left edge 42 and the left end 46 with typically this space being between three to five inches in length. This also means that the right end 44 is spaced from the right edge 40. The offset is to create a center mound in the ornament and to “flatten” the outermost upstanding members 28 at the base of the ornament. However, the offset is beneficial but not necessary. The release liner strip 62 is then removed with such removal being shown in FIG. 8 of the drawings. After removal of the release liner strip 62 an end of a core, such as an elongated rod 64, is placed on the adhesive strip 60 directly adjacent the right end 44. The core could comprise a structure such as rod 64 or could also comprise a hole. The user can then rotate the elongated rod 64 either clockwise or counterclockwise as indicated by arrow 66. This will result in the second section 24 and the first section 22 being wound on the elongated rod 64 with this winding procedure being indicated in FIG. 9 of the drawings. When completely wound, the first embodiment of decorative ornament 20 will be formed with the upstanding members 28 forming a mass of spikes 68 that extend in a three hundred sixty degree pattern from a center mound 70. The center mound 70 is formed by the second section 24. After the first section 22 and second section 24 are completely wound on the elongated rod 64, a securing band 72 is to be placed around the overlapped borders 30, 50 and 52 which prevents the unwinding of the first section 22 and the second section 24 from the elongated rod 64. The band 72 may not be necessary. If it is desired to use the first embodiment 20 of decorative ornament of this invention as a bow on a package, normally the elongated rod 64 will be cut directly adjacent the band 72. When utilizing of the first embodiment 20 of decorative ornament of this invention as a Christmas ornament, floral decoration or other type of ornament, there may be utilized some length of the elongated rod 64.

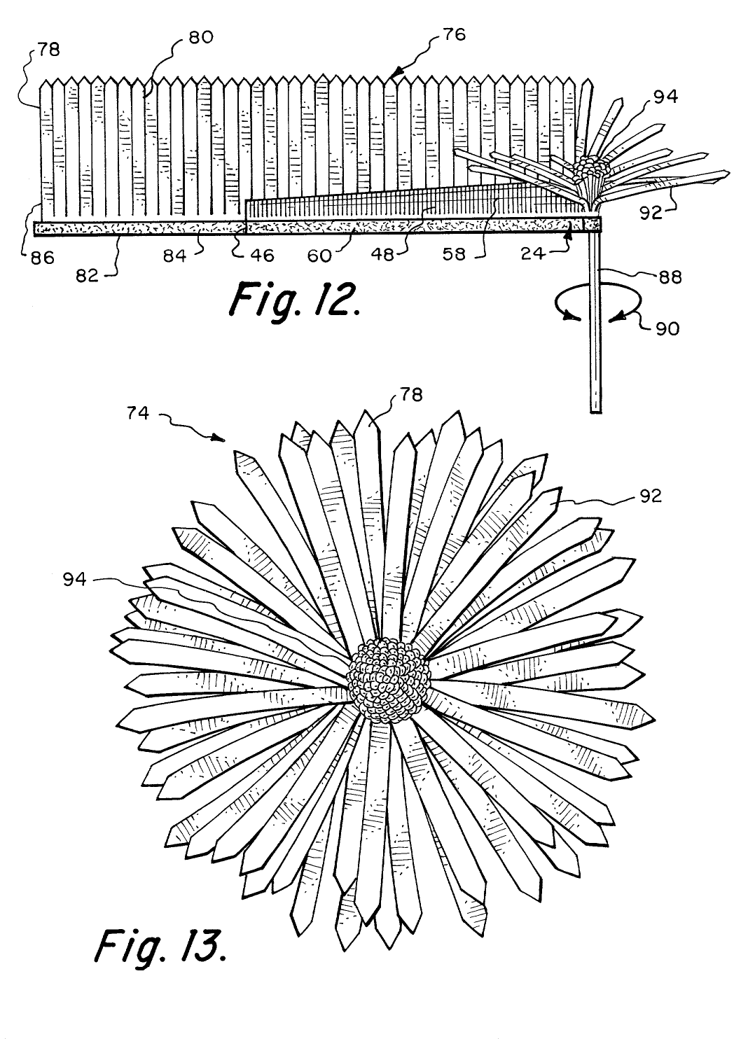

Referring particularly to FIGS. 12 and 13, there is shown a second embodiment 74 of decorative ornament of this invention. The second embodiment 74 is basically manufactured in the same way as the first embodiment 20, for a detailed description of the manufacturing operation reference is to be had to the prior description relating to the first embodiment 20. The second embodiment 74 uses the same second section 24 but need not be identical. However, the first section 76, though similar to the first section 22, does not include triangularly shaped upstanding members but instead includes upstanding members 78 that are basically in the shape of a picket fence stake where the side edges of each upstanding member 78 are parallel with their being slits 80 between each directly adjacent pair of upstanding members 78. The upstanding members 78 could have, instead of a spiked tip, curved tips or a decorative tip. The first section 76 also includes a solid uncut border 82 on which is been placed an adhesive strip 84. The border 50 of the second section 24 is to be placed against the adhesive strip 84 in the same manner that such occurred relative to the first embodiment 20. The second section 24 is located in an offset manner relative to the first section 76 with the left end 46 being spaced some distance from the left edge 86. A core, in the form of an elongated rod 88, has one end which is in contact with the adhesive 60 at the right end of the second section. Again, the elongated rod 88 is to be wound in either a clockwise or counterclockwise direction as indicated by arrow 90, and when completely wound will result in the forming of the second embodiment of decorative ornament 74 forming what resembles a circular pattern of picket fence stakes 92 which protrude from a center mound 94.

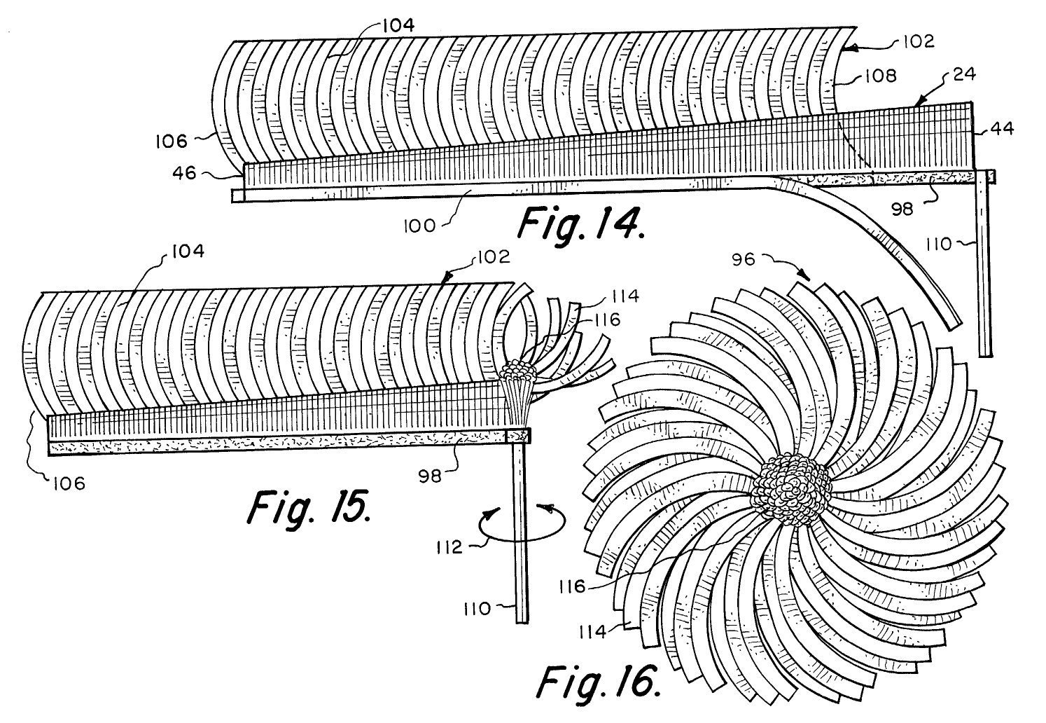

Referring particularly to FIGS. 14-16 of the drawings, there is shown a third embodiment 96 of decorative ornament which is to be formed again using an identical second section 24 which has an adhesive strip 98 which is covered prior to usage by a release liner strip 100. The second section 24 is located in contact with the first section 102, which instead of having a plurality of evenly spaced apart straight slits as there is in the second embodiment 74 of this invention, instead there are evenly spaced apart curved slits 104 formed within the first section 102. It is to be noted that the left edge 106 is almost aligned with the left end 46 with there being very little offset, if any. However, there may be included an offset if such is desired. There will normally be included an offset between the right end 44 and the right edge 108.

Winding of the first section 102 and the second section 24 onto the core, such as an elongated rod 110, in either clockwise or counterclockwise direction as indicated by arrow 112, will result in the producing of the decorative ornament 96 which has a circular pattern of curving strips 114 which extend from a center mound 116.

Although the subject matter of this invention has been primarily described using a polygonal shaped, flat first section and a trapezoidal shaped second section, it is considered to be within the scope of this invention to use two trapezoidal shaped sections which are connected together and wound on a core in the manner as previously described. When using of two trapezoidal shaped sections, both such sections may have loops. This will result in the production of a bow which has a circular array of loops located about a center mound that is also formed of loops. The appearance of such a bow is believed to be unique and attractive. Also, the trapezoidal shaped sections need not have loops which will result in an ornament with spikes that have unattached tips making an ornament with different length spikes that protrude from a center mound at different angles.

It is to be understood that although there are three different embodiments of the present invention shown, there may well be constructed numerous other embodiments in precisely the same manner. One way these embodiments can be constructed is by merely changing the configuration of the first section 24.

The present invention may be embodied in other specific forms without departing from the essential attributes thereof. Reference should be made to the appending claims rather than the foregoing specification as indicating the scope of the invention.

What is claimed is:

1. A decorative spiked ornament comprising:
a core;
a first section of sheet material having a plurality of thin, pliable, upstanding members located in a row and having free outer tips, said first section being wound on said core leaving said outer tips free; and
a second section of thin material having a plurality of pliable loops having apexes, said second section being wound on said core sequentially relative to said first section leaving said apexes free, said second section to form a center mound in the formed decorative spiked ornament.

2. The decorative spiked ornament as defined in claim 1 wherein:
said first section being of a polygonal shape.

3. The decorative spiked ornament as defined in claim 1 wherein:
said second section being of a trapezoid shape.

4. The decorative spiked ornament as defined in claim 1 wherein:
said upstanding members being sharp pointed.

5. The decorative spiked ornament as defined in claim 1 wherein:
said upstanding members being evenly spaced apart with there being a slit located between each directly adjacent pair of said upstanding members.

6. The decorative spiked ornament as defined in claim 5 wherein:
there being a plurality of said slits, said slits being located parallel.

7. The decorative spiked ornament as defined in claim 1 wherein:
said core comprising an elongated rod.

8. The decorative spiked ornament as defined in claim 1 wherein:
said first section having a first border, said second section having a second border, said second border overlaps said first border.

9. The decorative spiked ornament as defined in claim 8 wherein:
there being an adhesive located between said first border and said second border.

10. The decorative spiked ornament as defined in claim 1 wherein:
said first section being longitudinally offset from said second section.

11. A decorative spiked ornament comprising:
an elongated, thin, sheet material, pliable, first section having a plurality of upstanding members located in juxtaposition in a row, said upstanding members being fixed to a first border and extending transversely therefrom, each said member having a free outer tip;
an elongated, thin, sheet material, pliable, second section having a series of spaced apart slits forming a plurality of loops located in juxtaposition and arranged in a row, said loops being fixed to a second border and extending transversely therefrom, each said loop having a free apex;
said second section located against said first section with said first border abutting said second border forming a unified border and forming an assemblage; and
a core placed against said assemblage at said unified border at one end thereof with said assemblage to be completely wound on said core, whereby a decorative ornament is produced which has a center mound produced by said second section from which protrudes a circular array of elongated spiked members.

12. The decorative spiked ornament as defined in claim 11 wherein:
said upstanding members being sharp pointed.

13. The decorative spiked ornament as defined in claim 11 wherein:
said upstanding members being transversely curved.

14. The decorative spiked ornament as defined in claim 11 wherein:
said upstanding members all being of the same length.

15. The decorative spiked ornament as defined in claim 11 wherein:
said loops being evenly spaced apart.

16. The decorative spiked ornament as defined in claim 11 wherein:
said slits being located parallel.

17. The decorative spiked ornament as defined in claim 11 wherein:
said second section being trapezoidal shaped which causes said loops to all be of a different length.

18. The decorative spiked ornament as defined in claim 11 wherein:
said first section being of a polygonal shape.

19. The decorative spiked ornament as defined in claim 11 wherein:
said second section being smaller in area than said first section.

20. The decorative spiked ornament as defined in claim 11 wherein:
said core comprising an elongated rod.

21. The decorative spiked ornament as defined in claim 11 wherein:
there being an adhesive between said first border and said second border.

22. The decorative spiked ornament as defined in claim 11 wherein: said second section being longitudinally offset relative to said first section.

23. The decorative spiked ornament as defined in claim 11 wherein:
said first section is of a different length than said second section.

24. A method of making a decorative ornament comprising the steps of:
forming a first section of thin sheet material which has a first border from which extends transversely a plurality of first upstanding members located in juxtaposition and arranged in a row with each said member having a free outer tip;
forming a second section of thin sheet material which has a second border from which extends transversely a plurality of second upstanding members located in juxtaposition and arranged in a row with each said second upstanding members having a free apex;
placing said second border against said first border forming an assemblage; and
completely winding said assemblage on a core producing a decorative ornament which has a center mound produced by said second section from which protrudes a circular array of elongated members.

25. The method as defined in claim 24 which includes utilizing a second section of an area that is different from said first section.

26. The method of making a decorative ornament as defined in claim 24 wherein the first section is formed of a polygonal shape.

27. The method of making a decorative ornament as defined in claim 24 wherein the second section is formed of a trapezoidal shape.

28. The method of making a decorative ornament as defined in claim 24 wherein the second forming step includes selecting loops for said second upstanding members.

29. A decorative ornament comprising:
a core;
a first section of sheet material having a plurality of thin, pliable, first upstanding members located in a row and having free outer tips;
a second section of sheet material having a plurality of thin, pliable, second upstanding members having free apexes, both said first section and said second section being wound on said core with said second section overlapping a portion of said first section leaving said outer tips free and said apexes free, whereby a decorative ornament is produced which has a center mound produced by said second section from which protrudes a circular array of upstanding extending members.

30. A decorative ornament as defined in claim 29 wherein:
said first section having a first border to which said first upstanding members are attached and extend outwardly therefrom, a second section having a second border to which said second upstanding members are attached and extend outwardly therefrom, said first border and said second border being located in abutting juxtaposition.

31. A decorative ornament as defined in claim 29 wherein:
said second upstanding members comprising loops.

32. A decorative ornament as defined in claim 29 wherein:
said first upstanding members being evenly spaced apart with there being a slit located between each directly adjacent pair of said first upstanding members, said second upstanding members being evenly spaced apart with there being a slit being located between each adjacent pair of said second upstanding members.
